(19) United States
(12) Patent Application Publication
(10) Pub. No.: US 2011/0021663 A1
(43) Pub. Date: Jan. 27, 2011

(54) LIGHT WEIGHT AGGREGATE COMPOSITION

(76) Inventors: Abraham J. Sacks, Vancouver (CA); David L. Sacks, Vancouver (CA); William Spilchen, White Rock (CA); James Borchert, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/508,384

(22) Filed: Jul. 23, 2009

(51) Int. Cl. C08K 7/24; B32B 3/26; C04B 14/02; C08K 7/26

(52) U.S. Cl. 523/218; 428/402; 106/400

(57) ABSTRACT

An expanded material suitable for industrial application may have a nominal tap density from 0.18 grams/cc to 1.00 grams/cc and a wall thickness greater than 1.00 microns. The expanded material may take the form of an expanded silicate, for instance perlite, obsidian, pitchstone or vermiculite. A composition may include the expanded material in a dispersion, for example a resin dispersion, for instance a latex acrylic. Such may be particularly suitable as a partial or complete substitute for another aggregate used in the composition, such as sand. The composition may be suitable in structural applications, for example as an EIFS coat. The expanded material may, or may not, include a partial or complete hydrophobic coating.

### BACKGROUND

1. Field

This disclosure generally relates to compositions employing light weight aggregates, for instance expanded products.

2. Description of the Related Art

There are a variety of light weight aggregates that have industrial uses. Light weight aggregates can take a variety of forms, for example expanded products that have voids, cavities or interstices formed therein. Expanded products are typically materials that have been expanded, for example, by heating, and which as a result have relatively low bulk density in the expanded form. Expanded products may be produced from a variety of unexpanded or “raw” materials. For instance, many expanded products are produced from minerals, for example silicates such as perlite, vermiculite, hyperlite, expanded clay, pumice stone powder, obsidian, and pitch stone. Other expanded products are produced from various other materials, for example fly ash, glasses, phenolic materials. Expanded products may, for example, include glass that has voids, cavities or interstices formed therein, for instance via a gassing chemical or foaming agent, such as materials available under the trademark PORAVER®.

Expanded products are typically produced by heating the unexpanded or raw material to a desired temperature. The heating may transform the raw material into a plastic or glassy state. During heating, residual water in the raw material also heats, flashing to steam, and explosively expanding the material. The resulting expanded product typically is many times larger than the raw material, and is chambered, having numerous fissures or voids in the surface thereof.

Heating typically takes place in an expansion furnace. Numerous furnace designs have been employed or suggested over the years. Most recent designs employ a fluidized bed to carry the material generally upward on a heated stream of gas, for collection proximate a top of the expansion furnace. In particular, pressurized fuel and oxygen may enter a burner located proximate a bottom of the furnace, creating an upward flow of heated gas. Raw material may be supplied into the upward flowing stream just above the burner. The material heats and expands as the material is carried upward on the fluidized bed. Expanded material is collected proximate the top of the expansion furnace.

In some applications, the fissures and voids on the surface of light weight aggregate or expanded product may present a problem. For instance, such voids may allow water or other fluids to collect in the chambers or cavities of the expanded product. Such may disadvantageously increase the bulk density of the expanded product. Such may also adversely effect various traits of a composition, for example by drawing water or other fluid out of the composition. Attempts to solve such has traditionally employed application of various coatings to the expanded material. For example, cementitous coatings and silicone based coatings have been tried. Such coatings require additional processing of the expanded material, hence the use of additional energy and added manufacturing time and costs.

In some applications, the light weight aggregate or expanded product is subjected to substantial mechanical forces. For example, introducing the light weight aggregate or expanded product into a dispersion, for example a resinous dispersion may require mixing. Preparing a composition containing the expanded product for use may require mixing. Even applying, for example via trowel or spraying, a composition containing the light weight aggregate may subject the light weight aggregate or expanded material to substantial mechanical forces. A least one attempt has been made to try to strengthen the expanded material product in order to withstand the mechanical forces that may be applied in preparing and/or using compositions containing the expanded product.

Light weight aggregates or expanded products are used in a variety of applications. For example, expanded products may be used as loose fill insulation. Alternatively, expanded product may be added to another material, for example added as a filler. Expanded product may, for instance, be added as a filler to resinous and/or non-resinous compositions.

One particular application is use of expanded materials in finishes, for example in stucco finishes and/or exterior insulation finish systems (EIFSs).

Traditional stucco applications may employ a three coat or a two coat process. The three coat process typically includes a scratch coat, followed by a brown coat, which is then followed by a finish coat. The two coat process typically includes a single base coat and a finish coat applied over the base coat. The traditional formulation for the stucco coats typically include a Portland cement, hydrated lime and sand, in varying degrees, with water typically added at the job site. A lightweight aggregate, for instance an expanded perlite treated with a water resistant emulsion, may be substituted for some or all of the sand in the stucco, to reduce the bulk density of the resulting stucco composition. However, conventional expanded perlite appears incapable of withstanding the forces that are applied to the composition, for example during handling, mixing and/or application via a trowel.

EIFS is a multi-component system that may be applied to existing substrates of buildings and other structures. Typically EIFSs employ an insulation layer (e.g., insulation panels, for instance polystyrene) which may be adhered or otherwise mounted to an exterior surface of a substructure, such as sheathing. A base coat composition is applied to an exterior surface of the insulation. The base coat may include a Portland cement, an aggregate and/or or other suitable materials. Alternatively, the base coat may include a polymeric resin (e.g., acrylic latex), and aggregate and/or other suitable materials. Typically, a reinforcing mesh (e.g., glass fiber or polymeric) is embedded in the base coat. When the base coat is dry, a finish coat is applied to an exterior surface of the base coat. The finish coat is capable of providing or holding a textured finish. The finish coat may include a polymeric resin (e.g., acrylic latex) and an aggregate (e.g., sand) (commonly referred to as synthetic stucco), and/or the finish coat may employ other suitable materials. It has been suggested to substitute expanded product, for instance expanded mineral product such as expanded perlite, for other aggregate (e.g., sand) in the base coat and/or the finish coat of EIFS compositions. Such would advantageously reduce bulk density, and possible manufacturing costs. However, it appears that many attempts to incorporate expanded materials into such compositions have failed. This may be because of any of a variety of reasons, for instance water absorption by the expanded product, weakness of the expanded product, inability of the resulting composition to have or hold a texture or have other physical characteristic similar to that of a composition without the substitution of expanded product.

For example, it has been suggested that a composition include an expanded perlite with a weight of about 2.5 lb/ft³ (40 kg/m³) to 10.5 lb/ft³ (170 kg/m³) which is coated with a silicone based emulsion and having a density of 4.0 lb/ft³ to 4.4 lb/ft³. However, applicants have found that such coated expanded perlite is too weak and fragile for applications such as EIFS coatings or stucco coatings. Such coated expanded perlite tends to fracture during material handling, mixing, and plastering (i.e., application by trowel). A finish applied over a stucco base likely has to endure even larger forces than a finish applied over an EIFS base since stucco typically has relatively large particles of sand protruding from the surface. Thus, the expanded perlite described above would be even more likely to fail if used in a stucco composition.

New approaches to the use of light weight aggregates or expanded product, for instance expanded mineral product, are desirable to take advantage of the low bulk density such light weight aggregates offer.

### BRIEF SUMMARY

Applicants have realized that light weight aggregates or expanded product, for example expanded mineral product, having certain physical characteristics may be advantageously employed in a variety of industrial applications, for example in compositions suitable for use in structural applications such as stuccos and/or EIFSs. In particular, expanded product having a nominal tap density of from 0.18 grams/cubic centimeter (cc) to 1.00 grams/cc and a wall thickness greater than 1.00 microns may be useful in a variety of industrial applications, for example as a filler in resin based compositions. Such may advantageously be employed in resin based compositions used in structural applications, for example as a stucco base and/or finish coat or as a finish coat or “synthetic stucco” for use in exterior insulation finish system applications.

A composition may be summarized as including a plurality of pieces of an expanded product, the pieces of the expanded product having a wall thickness greater than 1.00 microns, and the expanded product having a nominal tap density of from 0.18 grams/cc to 1.00 grams/cc. The pieces of the expanded product may each have a plurality of cellular compartments with a maximum dimension that is not greater than about 30 microns. The expanded product may, for example, have a ratio of particle size (maximum dimension) to cell size (maximum dimension) of from about 15:1 to about 60:1.

Between about 30% to 100% of the pieces of the expanded product may be substantially ellipsoidal in shape. Between about 30% to 100% of the pieces of the expanded product may be substantially angular in shape. The pieces of expanded product may be partially coated with a hydrophobic material. The hydrophobic material may be a silicone based material. The composition may further include a resin dispersion into which the plurality of pieces of expanded product are dispersed. Between about 30% to 100% of the pieces of the expanded product may be substantially at least one of ellipsoidal or angular in shape. The composition may further include a resin dispersion into which the plurality of pieces of expanded product are dispersed. The composition may further include a resin dispersion into which the plurality of pieces of expanded product are dispersed. The resin dispersion may be an acrylic resin dispersion. The plurality of pieces of the expanded product may be a plurality of pieces of an expanded mineral product. The plurality of pieces of the expanded mineral product may be a plurality of pieces of an expanded silicate. The plurality of pieces of the expanded mineral product may be a plurality of expanded pieces of at least one of perlite, obsidian, pitchstone or vermiculite.

A method preparing a composition may be summarized as including providing a resin dispersion; and dispersing a plurality of pieces of an expanded product in the resin dispersion, the pieces of the expanded product having a wall thickness greater than 1.00 microns and the expanded product having a nominal tap density of from 0.18 grams/cc to 1.00 grams/cc.

Providing a resin dispersion may include providing a quantity of an acrylic resin. Dispersing a plurality of pieces of an expanded product in the resin dispersion may include dispersing a quantity of an expanded mineral product in the resin. Dispersing a plurality of pieces of an expanded mineral product in the resin dispersion may include dispersing a quantity of an expanded silicate. Dispersing a quantity of an expanded silicate may include dispersing at least one of perlite, obsidian, pitchstone or vermiculite. Dispersing a plurality of pieces of an expanded product in the resin dispersion may include dispersing a quantity of an expanded silicate partially covered with a hydrophobic material.

A method may be summarized as including providing a composition that includes at least a resin dispersion and an aggregate of an expanded product, the expanded product having a wall thickness greater than 1.00 microns and the expanded product having a nominal tap density of from 0.18 grams/cc to 1.00 grams/cc; and applying the composition as a finish coat in a structural application.

Providing a composition that includes at least a resin dispersion and an aggregate of an expanded product may include providing the composition that includes the expanded mineral product. Providing a composition that includes at least a resin dispersion and an aggregate of an expanded product may include providing the composition that includes the expanded mineral product bearing at least a partial hydrophobic coating. Applying the composition as a finish coat in a structural application may include applying the composition over a base layer in an exterior insulation finish system application.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an environment to produce a light weight aggregate or expanded product, optionally treat the expanded product, produce compositions including expanded product, package the compositions and use the same, according to one illustrated embodiment.

FIG. 2 is a micrograph showing a new expanded perlite according to one illustrated embodiment.

FIG. 3 is a micrograph showing a conventional expanded perlite according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with production of expanded product (e.g., expanded mineral product) such as expansion furnaces, optional coating (e.g., hydrophobic coatings) of expanded product such as sprayers, and production and/or use of compositions including expanded product such as mixers, trowels and sprayers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used herein and in the claims, the terms light weight aggregate and expanded product are used interchangeably to refer to a solid material that has sufficient voids, cavities and/or interstices as to provide a low bulk density filler material, whether such is expanded by heating trapped or residual liquid in the material or by forming the voids, cavities and/or interstices using other methods, for example via gassing chemicals or foaming agents.

The headings and Abstract of the Disclosure provided herein are for convenience only and do not interpret the scope or meaning of the embodiments.

As described herein, a variety of expanded product may be usefully employed in various industrial application. Such expanded product may be less expensive to use than other materials. Such expanded product may have a relatively low bulk density when compared to other materials, which the expanded product may partially or completely replace. For such expanded product to be commercially successful, the expanded product should not adversely effect the final composition in which the expanded product is the employed. The expanded product may replicate some of the physical characteristics of any material which the expanded product is partially or completely replacing in a composition. As used herein and the claims, the term composition is used in its broadest sense, and depending on context, may include simply a collection of the expanded product, or the expanded product with one or more additional components, for instance a dispersion such as a resin dispersion and/or another aggregate such as a sand aggregate.

It is noted that there is commonly a substantial discrepancy between the physical characteristics or parameters of individual particles of expanded product. For example, various shapes, sizes, densities, hardness, and other measures may significantly differ between individual particles of a same type of expanded product, even when produced as a single batch. Thus, many specific parameters are identified herein and in the claims in terms of averages. The term average is used to denote a measurement over a large volume of such expanded product, the volume being sufficiently large to supply a given application, wholesale or retail quantity of such expanded product or composition including the expanded product.

Applicants have determined that expanded product having one or more characteristics may be more suitable than other expanded product for inclusion in certain compositions and for use in certain applications.

In particular, expanded product having a relatively thick shell as compared to other expanded product may provide superior strength characteristics, closer to or even exceeding the strength of other bulk material which the expanded product may partially or completely replace. For example, expanded product having an average shell thickness that is at least greater than 2.0 microns, for example 3, 4 or 5 microns.

Also in particular, expanded product having a relatively small size, for instance as indicated by a maximum outer dimension, may provide superior strength characteristics, particularly when combined with a relatively thick shell.

Also in particular, expanded product that is non-spherical may provide superior strength characteristic and/or superior ability to achieve desired textures over expanded product that is generally spherical in shape. For example, where a substantial portion of the expanded product is ellipsoidal, the expanded product may be able to withstand various mechanical forces better than spherical expanded product. For instance, an aspect ratio of 1.3 (i.e., length is 1.3 times diameter). Also for example, where a substantial portion of the expanded product is angular (i.e., at least 5 facets with an aspect ratio of 1.3 to 1.5), the expanded product may be able to withstand various mechanical forces better than spherical expanded product. Thus, such non-spherical expanded product may be able to withstand mechanical forces associated with handling, mixing, packaging or use, for instance application via a trowel or spray nozzle. Such non-spherical shape may additionally, or alternatively, be able to provide textures desired in various applications, for instance structural applications such as exterior insulated finish system applications. Such non-spherical shape may be combined with the relatively large average wall thickness and/or relatively small size to provide particularly tough or strong expanded product, capable of providing desired textures.

The particles of the expanded product may each have a number of cellular compartments or voids therein. The cellular compartments or voids may advantageously have a maximum dimension of between about 10 microns and about 30 microns. The particles of expanded product may have a size of about 500 microns. Thus, for example, an expanded product with relatively thick walls and a relatively large number of relatively small cellular compartments or voids may have sufficient strength to withstand the various forces applied during handling, mixing and application. For example, expanded product having a particle size (maximum dimension) to cell size (maximum dimension) ratio of from about 15:1 to about 60:1 may be suitably strong to withstand forces likely to be encountered during normal handling, mixing and application.

Suitable expanded product may take a variety of forms including expanded versions of mineral products, for example silicates such as perlite, obsidian, pitchstone, vermiculite volcanic ash or similar silicates, or crushed shale or clay. The expanded product may take the form of expanded versions non-mineral products, such as fly ash, glass and/or phenolic materials.

Applicants believe that such expanded product may be suitable for use in various compositions even without a hydrophobic coating. However, a silicone emulsion may be partially applied to the expanded product to achieve a desired viscosity stability. In particular, a saline or silicon compound may be applied. For instance, a polydimethylsiloxane may be applied to the expanded product. As noted, such may only be applied to only a portion of each particle of the expanded product, since such does not appear necessary to sufficiently prevent or defer water absorption.

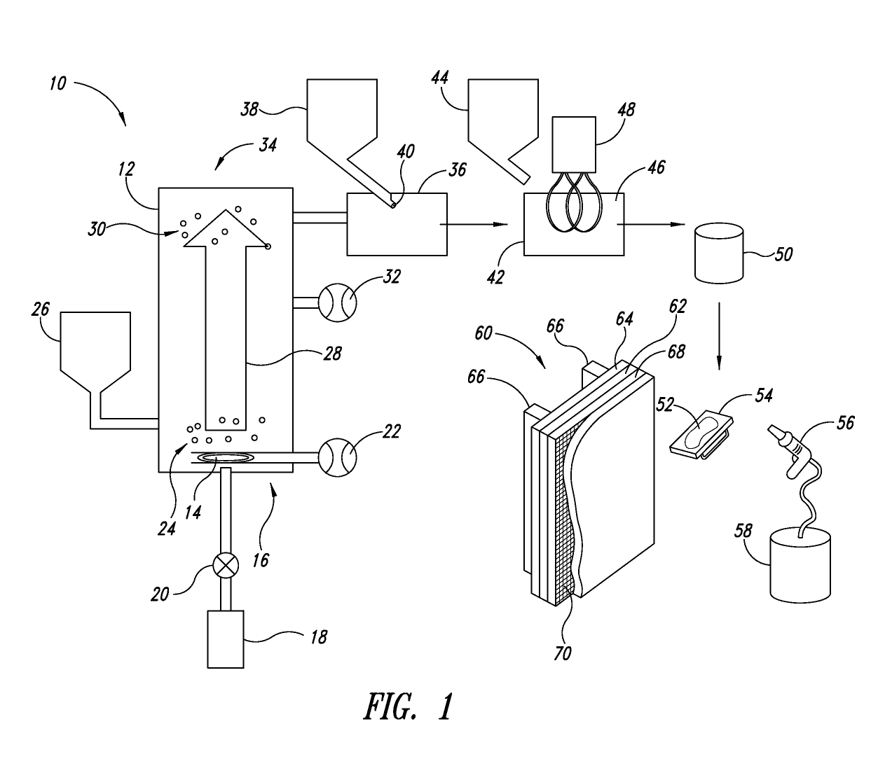

FIG. 1 shows an environment 10 in which expanded product is produced, incorporated into a final composition, packaged, and used, according to one illustrated embodiment.

In particular, the environment 10 includes an annealing expansion furnace 12, with a burner 14 proximate a bottom 16 thereof. The burner 14 receives a supply a fuel (e.g., natural gas, propane) via a fuel supply 18 and valve 20, and receives a supply of oxygen or air, for example via a blower 22. Raw or unexpanded product or material 24 is supplied from a raw product supply 26 to the annealing expansion furnace 12 via any of a variety of structures, for example a gravity feed or a conveyor. The raw or unexpanded product 24 in the raw product supply 26 may be treated or processed, for example to insure raw product of a desired size or range of sizes.

The raw or unexpanded product 24 is introduced into the annealing expansion furnace 12 relatively above the burner 14. The raw or unexpanded product 24 is heated (e.g., 850° C.) and moves upward as a fluidized bed or entrained bed, illustrated by arrow 28. Heat causes the raw unexpanded product 24 to transition into a plastic or glassy state, while at the same time causing liquid (e.g., water) entrapped in the unexpanded product 24 to flash to gas, causing the unexpanded product 24 to rapidly expand into expanded product 30. Introduction of cooling air, for example via a blower 32, may anneal the expanded product 30. Expanded product 30 is withdrawn from the annealing expansion furnace 12 proximate a top 34 thereof, by a suitable structure, for instance a cyclone.

The expanded product 30 may be produced using various techniques or may be commercially acquired where suitable expanded product is available.

For example, a dry surface treatment may be applied to raw or unexpanded product 24, for example pulverized raw or unexpanded product 24, prior to introduction of the raw or unexpanded product 24 to the annealing expansion furnace. Such may reduce or eliminate agglomeration, clumping and clogging. Suitable dry surface treatment may include methyl trimethoxy silane (SZ6070; Toray Dow Corning Silicone, 98% purity), silicone resin solution (SR2410; Toray Dow Corning Silicone, 23 mass % non-volatile solvent: ligroin methylbenzene), dimethyl polysiloxane (SH200; Toray Dow Corning Silicone) and calcium stearate). The dry surface treatment may, for example, be performed prior or during pulverization of the raw or unexpanded product 24. The raw or unexpanded product 24 may be subjected to a pre-heat treatment, for example in the range of 150° C.-300° C., for instance over a 12 hour period.

Also for example, the raw or unexpanded product 24 may be subjected to various preprocessing or pre-expansion operations. For instance, the raw or unexpanded product 24 may be may be dried, such as in a rotary kiln or oven. The raw or unexpanded product 24 may be screened, such as using a vibrating screen. The raw or unexpanded product 24 may be dressed for example using gravity separation or magnetic separation. The raw or unexpanded product 24 may be crushed, for instance using a jaw crusher. The raw or unexpanded product 24 may be pulverized or disintegrated, for instance via a JET mill or vibrating mill. The raw or unexpanded product 24 may be classified by specific gravity, for instance via an air classifier. Classification may be particular useful in production of raw or unexpanded product 24 suitable for use in producing the expanded product 30. Any or all of the above operations may be performed on raw or unexpanded product 24 prior to introduction into the annealing expansion furnace 12.

Also for example, the raw or unexpanded product 24 may be preheated prior to introduction to the annealing expansion furnace 12. One or more cyclones may be used to introduce the preheated raw or unexpanded product 24 into the annealing expansion furnace 12. For example, a series of cyclones with successively higher swirling draft flow velocities may be arranged to provide the raw or unexpanded product 24 to the annealing expansion furnace 12. Such may facilitate the formation of multi-chambers or multiples cells in the expanded product 30. The multi-chamber or multi-cellular nature of such particles of expanded product 30 may advantageously cause the particles of expanded product 30 to have a non-spherical shape.

Other details of pretreatment and expansion are discussed in various publications, including but not limited to: Japanese Patent Publication No. 2002-338280 published Nov. 27, 2002; Sodeyama, Sakka, Kamino, Seki, Nishimoto and Yazaki, The Manufacturing Process of Fine Shirasu Balloons Using a Fluidized Sand-Bed Furnace, Advanced Powder Technol., Vol. 11, No. 4, pp 503-516 (2000); Sodeyama, Sakka, Kamino, Tabata, Preparation and Characterization of Fine Shirasuballoons, Journal of the Ceramic Society of Japan (Japanese Version), Vol. 104, No. 0, pp 963-968 (1996); and Uemura, Nezu, Honda, Ohzuno, Ijichi and Hatate, Inorganic Microballoon Production From Shinju-Gan Using an Entrained Bed Reactor, Korean J. Chem. Eng., Vol. 16, No. 6, pp 837-839 (1999).

The expanded product 30 may optionally be forwarded to a chamber 36 for treatment with a silicone emulsion. The silicone emulsion may take the form of polydimethylsiloxane. The silicone emulsion may be supplied via a silicone supply 38 and applied to the expanded product 30 via any suitable mechanism, for instance one or more nozzles 40, where atomized or not. The silicone emulsion may be applied after the expanded product has cooled, at least below a temperature at which the silicone emulsion would vaporize. As previously noted, the silicone emulsion may be optionally used to achieve a desired viscosity stability, although the annealed expanded product 30 should be sufficiently resistant to absorption and/or adsorption to be useable without the silicone emulsion treatment. Also as noted, the expanded product 30 may only be partially coated with the silicone emulsion and still achieve the desired viscosity stability.

A resin dispersion may be supplied to a mixer chamber 42 from a resin supply 44. The silicone treated and/or untreated expanded product 30 may be dispersed into the resin dispersion in the mixer chamber 42 using suitable equipment, for instance an industrial mixer 46 driven by a motor 48. The silicone treated and/or untreated expanded product 30 may be cooled prior to mixing with the resin dispersion. As previously noted, the annealed expanded product may have suitable average shell thickness, tap density, size, and/or shape to withstand the mechanical forces applied via the mixing process.

The resin dispersion may take a variety of forms. For example, the resin dispersion may take the form of an acrylic resin or acrylic latex resin. The resin dispersion may take the form of a polyester resin. Other resins or polymers may be employed.

The expanded product included in the resulting composition may have an average wall thickness of greater than 1.00 microns, for example at least 3 microns, or 4 microns or about 5 microns. The expanded product included in the composition may have a nominal tap density of from about 0.18 grams/cc to about 1.00 grams/cc, for example less than 0.7 grams/cc, for instance 0.66 grams/cc or less. As used herein and in the claims, the terms “from” and “to” are inclusive, including the value which those terms precede. The expanded product included in the resulting composition may comprise between 30% to 100% of ellipsoidal shaped expanded product and/or 30% to 100% angular shaped expanded product. The expanded product included in the resulting composition may include a partial or complete hydrophobic coatings, for instance a silicone compound coating.

Additional material may be included in the final composition. For example, aggregate such a sand (e.g., silicon dioxide, calcium carbonate) or larger aggregate (e.g., stone). Also, for example, tints, pigments or other color components, as well as dispersing agents for such, may be included. Also for example, polyvinyl alcohol may be included, for example to stabilize an acrylic latex polymer. Also for example, water and/or mineral spirits or other solvents may be included. Additives conventionally used in exterior and interior coatings may also be included, for instance glycols, for instance ethylene glycol. Also for example, biocides, defoamers, and/or clay fillers may be included. Some suitable final compositions are set out in Table 1:

TABLE 1
Lightweight Acrylic Stucco Compositions Per Pail Jul. 17, 2009

| | |
|---|---|
| Scroll Formula | Scroll Formula |
| (Plant Trial #1) | (Plant Trial #2) |

| | Weight | Volume | Weight | Volume |
|---|---|---|---|---|
| Ingredient | (lb) | (Gal) | (lb) | (Gal) |
| Titanium Dioxide | 1.68 | 0.05 | 1.68 | 0.05 |
| Functional Filler | 0.47 | 0.02 | 0.47 | 0.02 |
| Dispersants | 0.35 | 0.04 | 0.35 | 0.04 |
| Solvents | 0.41 | 0.06 | 0.41 | 0.06 |
| Fine Filler | 1.97 | 0.09 | 1.97 | 0.09 |
| Water | 5.28 | 0.63 | 5.28 | 0.63 |
| Polymer Emulsion | 14.07 | 1.61 | 14.07 | 1.61 |
| Defoamer | 0.29 | 0.04 | 0.29 | 0.04 |
| Coalescent | 0.68 | 0.09 | 0.68 | 0.09 |
| Buffer | 0.01 | 0.00 | 0.01 | 0.00 |
| Biocide | 0.03 | 0.00 | 0.03 | 0.00 |
| Rheology Modifier | 0.29 | 0.03 | 0.29 | 0.03 |
| Sand | 7.30 | 0.32 | 7.30 | 0.32 |
| Perlite | 17.78 | 2.01 | 16.55 | 2.01 |
| TOTAL | 50.62 | 5.00 | 49.39 | 5.00 |

The resulting final composition including the expanded product in the resin dispersion may be packaged, for example in buckets 50, such as five gallon buckets via conventional packaging equipment. As previously noted, the annealed expanded product may have suitable average shell thickness, tap density, size, and/or shape to withstand the mechanical forces applied via the packaging process, as well as forces incurred during the transportation of the final composition.

The final composition 52 (illustrated on trowel) may be applied via any variety of devices suitable for a particular end use application. For example, the final composition 52 may be applied via a trowel 54. Alternatively, the final composition 52 may be applied via a spray gun 56 or similar device from a pressurized source such as a pump 58. The spray gun 54 may be air-assisted spray or airless. Alternatively, a brush, roller, mop, squeegee, caulk gun and the like may be employed, depending on the specific application. As previously noted, the annealed expanded product may have suitable average shell thickness, tap density, size, and/or shape to withstand the mechanical forces applied via use or application process, for example being applied via a trowel 54 or spray gun 56.

One application for which the final composition may be particular suited is an EIFS application, illustrated generally as 60.

An EIFS application 60 may include an insulation layer 62 applied to an exterior surface of a substructure of a structure, for example sheathing 64 supported by studs 66. The insulation layer 62 can take a variety for forms, including for example insulation panels, for instance polystyrene panels.

The EIFS application 60 may include a base coat 68 applied to an exterior surface of the insulation layer 62. The base coat 68 may take a variety of forms, for example a composition including a resin such as an acrylic or acrylic latex or alternatively a cement such as a Portland cement. The base coat 68 may include an aggregate, for example a sand, and/or the expanded product. The EIFS application may include a reinforcement structure. For example, the EIFS may include a reinforcement mesh 70, for instance a glass fiber or polymer mesh, embedded in the base coat.

The EIFS application may include a finish coat 72, applied over an exterior surface of the base coat 68 and the reinforcing mesh 70. FIG. 1 shows the finish coat 72 partially applied to better illustrate the base coat 68 and reinforcing mesh 70. The finish coat 72 may take a variety of forms capable of providing or holding a texture, for example a composition of a resin such as an acrylic or acrylic latex, and an aggregate. The aggregate may take the form of the expanded product. The aggregate may additionally include a sand, for instance a calcium carbonate (CaCO₃) sand.

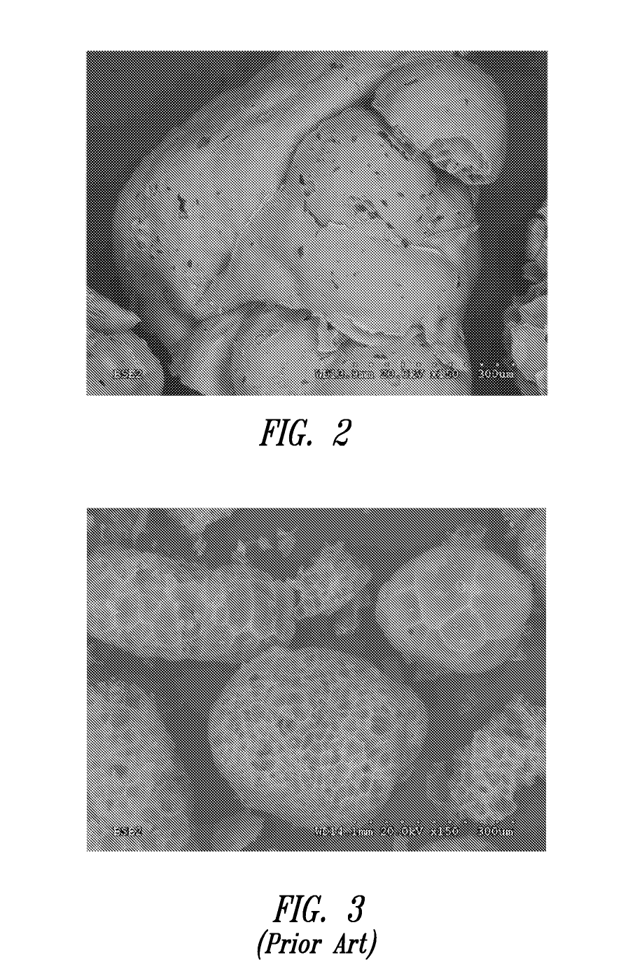

FIG. 2 shows pieces or particles of an expanded product in the form of an expanded mineral, in particular an expanded perlite, according to one illustrated embodiment. The expanded perlite has a relative large wall thickness, a relatively small maximum dimension (e.g., longitudinal dimension), is non-spherical and has a relatively small tap density. In particular, the average wall thickness is greater than 1.00 micron, for example at least 3 microns, or at least 4 microns or about 5 microns. The nominal tap density is from 0.18 grams/cc to 1.00 grams/cc.

FIG. 3 shows pieces or particles of a conventional expanded product in the form of an expanded mineral, in particular an expanded perlite available from Silbrico Corporation, LaGrange, Ill. The expanded perlite of FIG. 3 has a relative small wall thickness, a relatively large maximum dimension, is substantial spherical and has a relatively low tap density. The shell is thin, ranging from 0.5 microns to 2.0 microns, with average less than 1 micron. The shell is so thin as to be essentially transparent. The average of the maximum dimension is also relatively large compared to average maximum dimension of the expanded perlite of FIG. 2.

Two acrylic stucco compositions employing expanded perlite having the above described characteristics were tested. The surprisingly good results of the testing are set out in the Tables 2 and 3, below.

TABLE 2

| Day | Date | Density (g/cc) | Viscosity (KU) |
|---|---|---|---|
| 19 | 27 May 2008 | 1.179 | 125-128 |
| 26 | 03 Jun. 2008 | 1.180 | 126.5-128.5 |
| 33 | 10 Jun. 2008 | 1.135 | 127.5-128.5 |
| 40 | 17 Jun. 2008 | 1.163 | 125.5-127 |
| 47 | 24 Jun. 2008 | 1.163 | 128-130 |
| 64 | 14 Jul. 2008 | 1.193 | 127-130 |
| 71 | 21 Jul. 2008 | 1.158 | 131-133 |
| 78 | 28 Jul. 2008 | 1.140 | 134-136 |
| 95 | 14 Aug. 2008 | 1.114 | 132-133 |
| 107 | 26 Aug. 2008 | 1.086 | 130-132 |
| 109 | 28 Aug. 2008 | 1.151 | 133-135 |
| 143 | 1 Oct. 2008 | 1.119 | 132-134 |
| 173 | 31 Oct. 2008 | 1.116 | 134-136 |
| 382 | 25 May 2009 | 1.161 | 140-140.5 |

TABLE 3

| Day | Date | Density (g/cc) | Viscosity (KU) |
|---|---|---|---|
| 0 | Jul. 26, 2008 | 1.159 | 103-110 |
| 3 | Jul. 29, 2008 | 1.117 | 116-118 |
| 10 | Aug. 5, 2008 | 1.122 | 111-114 |
| 19 | Aug. 14, 2008 | 1.089 | 110.5-113.5 |
| 31 | Aug. 26, 2008 | 1.075 | 112-114 |
| 46 | Sep. 10, 2008 | 1.061 | 116-118 |
| 67 | Oct. 1, 2008 | 1.115 | 119-120 |
| 97 | Oct. 31, 2008 | 1.093 | 117-119 |
| 128 | Dec. 1, 2008 | 1.106 | 121-123 |
| 306 | May 25, 2009 | 1.104 | 121-123 |

### Examples

A first composition denominated as a “scroll” composition may include an acrylic resin, and expanded aggregate that falls into three distinct size ranges, set out in Table 4. The “scroll” composition may include additional components, such as calcium carbonate also as set out in Table 4, as well as tints or pigments, water, and various other components, for example the various components discussed above.

TABLE 4

| Size Range | SG | SG | Tap Density | | | wt | wt | |
|---|---|---|---|---|---|---|---|---|
| (um) | (g/cc) | (lb/cuft) | (g/cc) | wt % | vol % | (lb) | (kg) | vol % |
| 0-150 | 1.3 | 81.2 | 0.657 | 5.0% | 3.2% | 0.6 | 0.3 | 41.3% |
| 150-300 | 0.7 | 43.7 | 0.553 | 42.5% | 42.0% | 5.1 | 2.3 | |
| 300-710 | 0.75 | 46.8 | 0.466 | 52.5% | 54.8% | 6.8 | 3.1 | |

| | | |
|---|---|---|
| Large CaCO3 Sand | 16.1% | 6.5% |
| Fine CaCO3 Filler | 4.3% | 1.6% |

| | |
|---|---|
| Pail Weight (lb) | 45.0 |
| Pail Weight (kg) | 20.4 |

A second composition denominated as a “fine sand float” composition may include an acrylic resin, and expanded aggregate that falls into one range of sizes, as set out in Table 5. Note, SG stands for specific gravity (i.e., displacement in a wet mixture). The “fine sand float” composition may include additional components, such as calcium carbonate also as set out in Table 5, as well as tints or pigments, water and various other components, for example the various components discussed above.

TABLE 5

| Size Range | SG | SG | Tap Density | | | wt | wt | |
|---|---|---|---|---|---|---|---|---|
| (um) | (g/cc) | (lb/cuft) | (g/cc) | Wt % | vol % | (lb) | (kg) | vol % |
| 710-850 | 0.95 | 59.3 | 0.300 | 100.0% | 100.0% | 13.2 | 6.0 | 36.4% |

| | | |
|---|---|---|
| Large CaCO3 Sand | 0.0% | 0.0% |
| Fine CaCO3 Filler | 13.0% | 5.7% |

| | |
|---|---|
| Pail Weight (lb) | 40.0 |
| Pail Weight (kg) | 18.1 |

A second composition denominated as a “fine sand float” composition may include an acrylic resin, and expanded aggregate that falls into one range of sizes, as set out in Table 6. The “medium sand float” composition may include additional components, such as calcium carbonate also set out in Table 6, as well as tints or pigments, water and various other components, for example the various components discussed above.

TABLE 6

| Size Range | SG | SG | Tap Density | | | wt | wt | |
|---|---|---|---|---|---|---|---|---|
| (um) | (g/cc) | (lb/cuft) | (g/cc) | Wt % | vol % | (lb) | (kg) | vol % |
| 850-1400 | 0.53 | 33.1 | 0.180 | 100.0% | 100.0% | 7.1 | 3.2 | 34.7% |

| | | |
|---|---|---|
| Large CaCO3 Sand | 0.0% | 0.0% |
| Fine CaCO3 Filler | 17.4% | 6.7% |

| | |
|---|---|
| Pail Weight (lb) | 45.0 |
| Pail Weight (kg) | 20.4 |

The expanded products taught herein may be used as a component in various compositions, and may be used as a filler, for example as a low cost, low bulk density filler. The expanded products may be combined into liquid, paste, or solid compositions. For instance, the expanded mineral products taught herein may be used in stucco. Alternatively, the expanded mineral products taught herein may be used in acrylic based structural or architectural coatings such as the class of coatings or compositions commonly termed “synthetic stucco.” Such may also be suitable for inclusion in plastics (e.g., thermoplastic or thermosetting), paints, plasters, masonary, insulation, textures, joint compounds, spackling compounds, caulking formulations, cements or concretes, and/or automobile putties. Such may also be suitable for use as horticultural aggregate, insulation, and/or filter media.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other expanded products compositions and compositions containing expanded product, not necessarily the exemplary expanded perlite and EIFS suitable composition generally described above. The various embodiments described above can be combined to provide further embodiments.

To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ systems, structures, methods and concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A composition, comprising:
a plurality of pieces of an expanded product, the expanded product having a wall thickness on average of greater than about 1.00 microns and the expanded product having a nominal tap density of from 0.18 grams/cubic centimeter (cc) to 1.00 grams/cc.

2. The composition of claim 1 wherein the wall thickness of the expanded product is at least 3 microns.

3. The composition of claim 1 wherein the wall thickness of the expanded product is at least 4 microns.

4. The composition of claim 1 wherein the wall thickness of the expanded product is about 5 microns.

5. The composition of claim 1 wherein the pieces of the expanded product each have a number of cellular compartments with a maximum dimension that is not greater than about 30 microns.

6. The composition of claim 1 wherein the nominal tap density of the expanded product is less than 0.7 grams/cc.

7. The composition of claim 1 wherein between about 30% to 100% of the pieces of the expanded product are substantially ellipsoidal in shape.

8. The composition of claim 1 wherein between about 30% to 100% of the pieces of the expanded product are substantially angular in shape.

9. The composition of claim 1 wherein the pieces of expanded product are partially coated with a hydrophobic material.

10. The composition of claim 9 wherein the hydrophobic material is a silicone based material.

11. The composition of claim 9, further comprising:
a resin dispersion into which the plurality of pieces of expanded product are dispersed.

12. The composition of claim 1 wherein between about 30% to 100% of the pieces of the expanded product are substantially at least one of ellipsoidal or angular in shape.

13. The composition of claim 12, further comprising:
a resin dispersion into which the plurality of pieces of expanded product are dispersed.

14. The composition of claim 1, further comprising:
a resin dispersion into which the plurality of pieces of expanded product are dispersed.

15. The composition of claim 14 wherein the resin dispersion is an acrylic resin dispersion.

16. The composition of claim 14, further comprising:
a calcium carbonate sand dispersed in the resin dispersion.

17. The composition of claim 14, further comprising:
a silica sand dispersed in the resin dispersion.

18. The composition of claim 1 wherein the plurality of pieces of the expanded product are a plurality of pieces of an expanded mineral product.

19. The composition of claim 18 wherein the plurality of pieces of the expanded mineral product are a plurality of pieces of a silicate.

20. The composition of claim 18 wherein the plurality of pieces of the expanded mineral product are a plurality of expanded pieces of at least one of perlite, obsidian, pitchstone or vermiculite.

21. A method of preparing a composition, comprising:
providing a resin dispersion; and
dispersing a plurality of pieces of an expanded product in the resin dispersion, the pieces of the expanded product having on average a wall thickness greater than 1.00 microns, and the expanded product having a nominal tap density of from 0.18 grams/cubic centimeter (cc) to 1.00 grams/cc.

22. The method of claim 21 wherein providing a resin dispersion comprises providing a quantity of an acrylic resin.

23. The method of claim 21 where dispersing a plurality of pieces of an expanded product in the resin dispersion includes dispersing a quantity of an expanded mineral product having an average wall thickness of at least 3 microns in the resin dispersion.

24. The method of claim 23 where dispersing a plurality of pieces of an expanded mineral product in the resin dispersion includes dispersing a quantity of an expanded silicate having an average wall thickness of at least 4 microns in the resin dispersion.

25. The method of claim 24 where dispersing a quantity of an expanded silicate includes dispersing at least one of perlite, obsidian, pitchstone or vermiculite having an average wall thickness of about 5 microns in the resin disperson.

26. The method of claim 21 where dispersing a plurality of pieces of an expanded mineral product in the resin dispersion includes dispersing a quantity of an expanded silicate partially covered with a hydrophobic material.

27. A method, comprising:
providing a composition that includes at least a resin dispersion and an aggregate of an expanded product, the expanded product having a nominal tap density of from 0.18 grams/cubic centimeter (cc) to 1.00 grams/cc and an average wall thickness greater than 1.00 microns; and
applying the composition as a finish coat in a structural application.

28. The method of claim 27 wherein providing a composition that includes at least a resin dispersion and an aggregate of an expanded product includes providing the composition that includes the expanded product having an average wall thickness of at least 4 microns.

29. The method of claim 27 wherein providing a composition that includes at least a resin dispersion and an aggregate of an expanded product includes providing the composition that includes an expanded mineral product bearing at least a partial hydrophobic coating.

30. The method of claim 27 wherein applying the composition as a finish coat in a structural application includes applying the composition over a base layer in an exterior insulation finish system application.
